(19) United States
(12) Patent Application Publication
(10) Pub. No.: US 2026/0044034 A1
(43) Pub. Date: Feb. 12, 2026

(54) INSPECTION DEVICE AND DISPLAY PANEL INSPECTION METHOD

(71) Applicants: HKC Corporation Limited, Baoan Dist, Shenzhen (CN); Chongqing HKC Optoelectronics Technology Co., Ltd., Chongqing (CN)

(72) Inventor: CHUNG-KUANG CHIEN, Chongqing (CN)

(21) Appl. No.: 15/740,358

(22) PCT Filed: Jul. 26, 2017
(86) PCT No.: PCT/CN2017/094521

§ 371 Date: Jan. 15, 2018

(30) Foreign Application Priority Data
May 29, 2017 (CN) 201710383521.3

(51) Int. Cl. G02F 1/133; G02F 1/1335; G02F 1/1339; G09G 3/36

(52) U.S. Cl. CPC G02F 1/13306; G02F 1/133514; G02F 1/13398; G09G 3/3674

(57) ABSTRACT

An inspection device and a display panel inspection method are provided. The inspection device includes a main frame; a guide plate, connected to the main frame; a self-return guide rod structure, slidably coupled to the guide plate; a press limit structure, coupled to the guide plate and configured to limit the self-return guide rod structure to slide within a predetermined range; a press handle structure, coupled to an upper portion of the self-return guide rod structure and the main frame respectively; and an indenter structure, located under the guide plate and coupled to a lower end of the self-return guide rod structure.

### CROSS-REFERENCE TO RELATED APPLICATION

This application claims the benefit of China Patent Application No. 201710383521.3, filed on May 26, 2017, in the State Intellectual Property Office of the People's Republic of China, the disclosure of which is incorporated herein in its entirety by reference.

### FIELD OF THE INVENTION

The present invention relates to the display panel technology, and more particularly to an inspection device and a display panel inspection method using the inspection device.

### BACKGROUND OF THE INVENTION

With the development of science and technology and the advancement of society, displays are widely used at home and offices. The requirements for the function and quality of displays are getting stricter and stricter. A display panel is a core component of a display. In the process of producing a display panel, the display panel may have fine particles thereon. The particles will cause point defects or line defects of the display panel. Therefore, it is necessary to inspect the dead pixels by pressing the display panel. In general, the inspection is performed manually. However, the press force cannot be kept uniform, so the inspection result may be inaccurate. The operator needs to be specially trained for performing the actual inspection operation. The inspection process needs much manpower and material resources, and the accuracy of the result is poor.

### SUMMARY OF THE INVENTION

The primary object of the present invention is to provide an inspection device to solve the problem that it is not easy to keep a uniform press force when the surface of the display panel is inspected for dead pixels.

According to one aspect of the present invention, an inspection device is provided. The inspection device comprises a main frame, a guide plate, a self-return guide rod structure, a press limit structure, a press handle structure, and an indenter structure. The guide plate is connected to the main frame. The self-return guide rod structure is slidably coupled to the guide plate. The press limit structure is coupled to the guide plate. The press limit structure is configured to limit the self-return guide rod structure to slide within a predetermined range. The press handle structure is coupled to an upper portion of the self-return guide rod structure and the main frame respectively. The indenter structure is located under the guide plate and coupled to a lower end of the self-return guide rod structure.

In one embodiment, the self-return guide rod structure includes at least one guide rod, a connecting block, and a return spring. The guide rod has a longitudinal axis parallel to a slide direction of the guide plate. The guide rod is inserted through a guide hole of the guide plate. A lower end of the guide rod is coupled to the indenter structure. The connecting block is fixedly connected to an upper portion of the guide rod and coupled to the press handle structure. The return spring is fitted on an outer periphery of the guide rod. One end of the return spring leans against the connecting block, and another end of the return spring leans against the guide plate.

In one embodiment, the least one guide rod has two guide rods which are parallel to each other.

In one embodiment, the press handle structure includes a connecting seat, a press handle, and a connecting rod. The connecting seat is connected to the main frame. One end of the press handle is hinged to the connecting seat. One end of the connecting rod is hinged to a middle portion of the press handle, and another end of the connecting rod is hinged to the connecting block.

In one embodiment, a hinge axle of the connecting seat and the press handle and a hinge axle of the press handle and the connecting rod are perpendicular to the slide direction of the guide plate.

In one embodiment, the press limit structure includes a limit adjustment assembly and a limit block. The limit adjustment assembly is configured to drive the limit block to move in a direction parallel to the slide direction of the guide plate. The limit block is located under the connecting block. An upper end surface of the limit block is configured to lean against a lower end surface of the connecting block. The limit block is coupled to the guide plate through the limit adjustment assembly.

In one embodiment, the limit adjustment assembly includes at least two guide screw rods, guide nuts corresponding to the guide screw rods respectively, and guide seats corresponding to the guide nuts respectively. The guide screw rods are disposed on the guide plate. The guide screw rods each have a longitudinal axis parallel to the longitudinal axis of the guide rod. The guide nuts are screwed to the guide screw rods, respectively. The guide seats are fitted on the guide screw rods, respectively. The guide seats are located on top of the guide nuts respectively and coupled to the limit block.

In one embodiment, the inspection device further comprises at least one pointer and at least one scale corresponding to the pointer. The pointer is connected to a corresponding one of the guide seats. The scale is disposed at an outer side of the corresponding guide seat and located on the guide plate.

In one embodiment, the press limit structure further includes a locking nut located at an upper portion of each guide seat, and the locking nut is engaged with the upper portion of each guide seat.

In one embodiment, the press limit structure includes a limit plate and a limit rod. The limit plate is disposed on the guide plate. The limit plate is provided with perforations. The limit rod is coupled to the limit plate through the perforations. The limit rod is located under the connecting block. An upper end surface of the limit rod is configured to be in contact with a lower end surface of the connecting block.

In one embodiment, the press limit structure further includes fixing nuts, and the fixing nuts are detachably coupled to two end of the limit rod.

In one embodiment, the limit rod is insertedly coupled to the fixing nuts.

In one embodiment, the indenter structure includes a support frame and a contact block. The support frame is coupled to the lower end of the self-return guide rod structure. The contact block is disposed at a lower portion of the support frame. A lower end of the contact block extends out of a lower end of the support frame.

In one embodiment, the contact block has a curved contact surface.

According to another aspect of the present invention, an inspection device is provided. The inspection device comprises a main frame, a guide plate, a self-return guide rod structure, a press limit structure, a press handle structure, and an indenter structure. The guide plate is connected to the main frame. The self-return guide rod structure is slidably coupled to the guide plate. The press limit structure is coupled to the guide plate. The press limit structure is configured to limit the self-return guide rod structure to slide within a predetermined range. The press handle structure is coupled to an upper portion of the self-return guide rod structure and the main frame respectively. The indenter structure is located under the guide plate and coupled to a lower end of the self-return guide rod structure. The self-return guide rod structure includes at least one guide rod, a connecting block, and a return spring. The guide rod has a longitudinal axis parallel to a slide direction of the guide plate. The guide rod is inserted through a guide hole of the guide plate. A lower end of the guide rod is coupled to the indenter structure. The connecting block is fixedly connected to an upper portion of the guide rod and coupled to the press handle structure. The return spring is fitted on an outer periphery of the guide rod. One end of the return spring leans against the connecting block, and another end of the return spring leans against the guide plate. The press handle structure includes a connecting seat, a press handle, and a connecting rod. The connecting seat is connected to the main frame. One end of the press handle is hinged to the connecting seat. One end of the connecting rod is hinged to a middle portion of the press handle, and another end of the connecting rod is hinged to the connecting block. The press limit structure includes a limit adjustment assembly and a limit block. The limit adjustment assembly is configured to drive the limit block to move in a direction parallel to the slide direction of the guide plate. The limit block is located under the connecting block. An upper end surface of the limit block is configured to lean against a lower end surface of the connecting block. The limit block is coupled to the guide plate through the limit adjustment assembly. The limit adjustment assembly includes at least two guide screw rods, guide nuts corresponding to the guide screw rods respectively, and guide seats corresponding to the guide nuts respectively. The guide screw rods are disposed on the guide plate. The guide screw rods each have a longitudinal axis parallel to the longitudinal axis of the guide rod. The guide nuts are screwed to the guide screw rods, respectively. The guide seats are fitted on the guide screw rods, respectively. The guide seats are located on top of the guide nuts respectively and coupled to the limit block. The indenter structure includes a support frame and a contact block. The support frame is coupled to the lower end of the self-return guide rod structure. The contact block is disposed at a lower portion of the support frame. A lower end of the contact block extends out of a lower end of the support frame.

In one embodiment, the least one guide rod has two guide rods which are parallel to each other.

In one embodiment, a hinge axle of the connecting seat and the press handle and a hinge axle of the press handle and the connecting rod are perpendicular to the slide direction of the guide plate.

In one embodiment, the inspection device further comprises at least one pointer and at least one scale corresponding to the pointer. The pointer is connected to a corresponding one of the guide seats. The scale is disposed at an outer side of the corresponding guide seat and located on the guide plate.

In one embodiment, the press limit structure further includes a locking nut located at an upper portion of each guide seat, and the locking nut is engaged with the upper portion of each guide seat.

According to a further aspect of the present invention, a display panel inspection method is provided. The display panel inspection method comprises the steps of: adjusting a press limit structure to limit slide displacement of a self-return guide rod structure within a predetermined range; placing and securing a display panel to a worktable, an area to be inspected of the display panel corresponding in position to an indenter structure; providing a press handle structure to drive the indenter structure to approach the display panel until the self-return guide rod structure is moved to a maximum displacement; obtaining a distribution situation of dead pixels in the area to be inspected; and controlling the press handle structure for the self-return guide rod structure to drive the indenter structure and the press handle structure to return to an initial position.

The inspection device of the present invention is used for pressing a display panel through the press handle structure to drive the self-return guide rod structure so as to move the indenter structure. The inspection device of the present invention also includes the press limit structure to limit the self-return guide rod structure to slide in the up-down direction within the predetermined range, so that the maximum displacement of each press is limited, that is, when pressed to the lowest, each press is able to reach the specific press force. The press force each time can be kept the same to improve the accuracy of the inspection. Besides, the operator without special training can use the inspection device to perform inspection operations, thereby saving manpower and resources, reducing production costs and improving product quality.

The display panel inspection method of the present invention uses the aforesaid inspection device. When the display panel is pressed for inspection, the press force can be unified, that is, the press force corresponding to the maximum displacement position, so that the accuracy of the inspection is improved to save manpower and material resources, reduce production costs and improve product quality. In addition, after finishing the press, the press handle structure and the indenter structure are automatically returned to the initial position, and the operator does not need to return them manually, further improving the working efficiency.

### BRIEF DESCRIPTION OF THE DRAWINGS

FIG. 1 is a front schematic view of an inspection device in accordance with one embodiment of the present invention;

FIG. 2 is a rear schematic view of an inspection device in accordance with one embodiment of the present invention;

FIG. 3 is a schematic view of an inspection device in accordance with one embodiment of the present invention when in use;

FIG. 4 is a schematic view showing the installation of a guide plate, a self-return guide rod structure and a press limit structure in FIG. 1;

FIG. 5 is a front schematic view of an inspection device in accordance with another embodiment of the present invention;

FIG. 6 is a front schematic view of an inspection device in accordance with a further embodiment of the present invention;

FIG. 7 is a block diagram of an inspection device in accordance with one embodiment of the present invention; and

FIG. 8 is a flow chart of a display panel inspection method of the present invention.

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

Throughout the description of the present disclosure, it should be understood that the terms “installed,” “connected,” and “coupled” should be broadly interpreted, unless the context clearly indicates otherwise, for example, it may be fixedly connected, detachably connected, or integrally connected; it be a mechanically connected or electrically connected; it may be directly connected or indirectly connected through an intermediate medium; it be an internal connection of two components. It will be apparent to those skilled in the art that the specific meaning of the above terms in this description.

Throughout the description of the present disclosure, spatially relative terms, such as “length,” “width,” “upper,” “lower,” “front,” “rear,” “left,” “right,” “vertical,” “horizontal,” “top,” “bottom,” “inner,” “outer” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures.

It will be understood that, although the terms “first,” “second” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. Throughout the description of the present disclosure, unless the context clearly indicates otherwise, the meaning of “plural”is two or more.

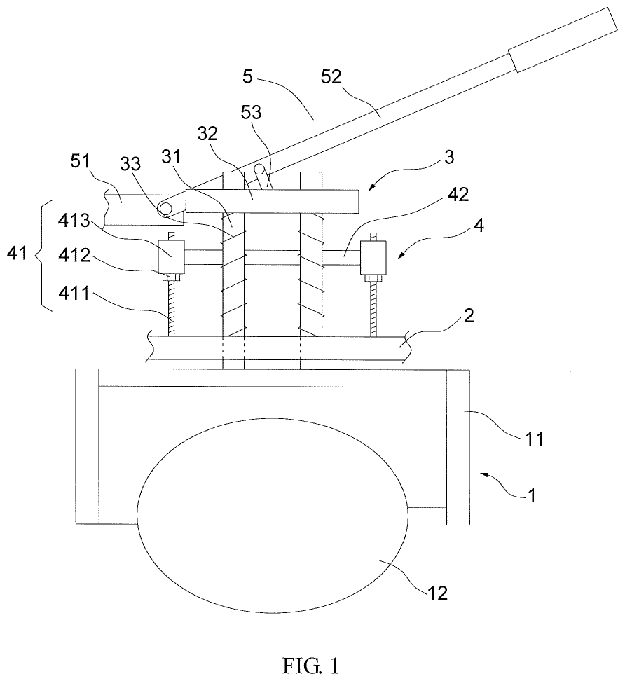

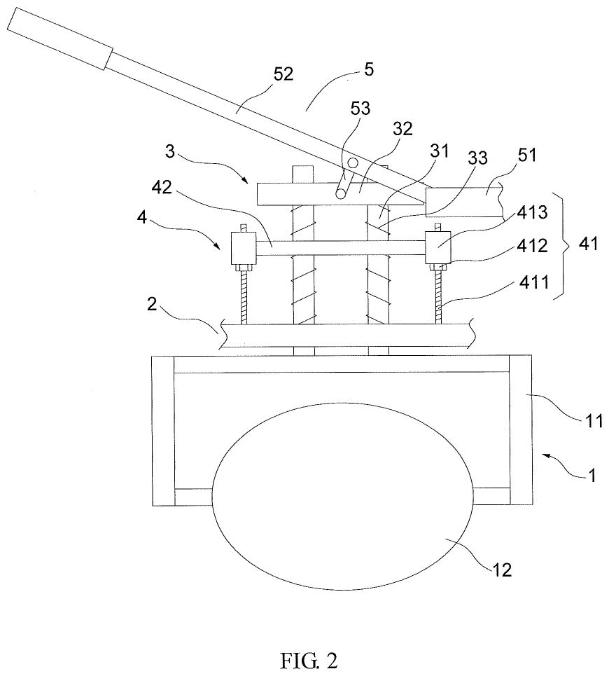

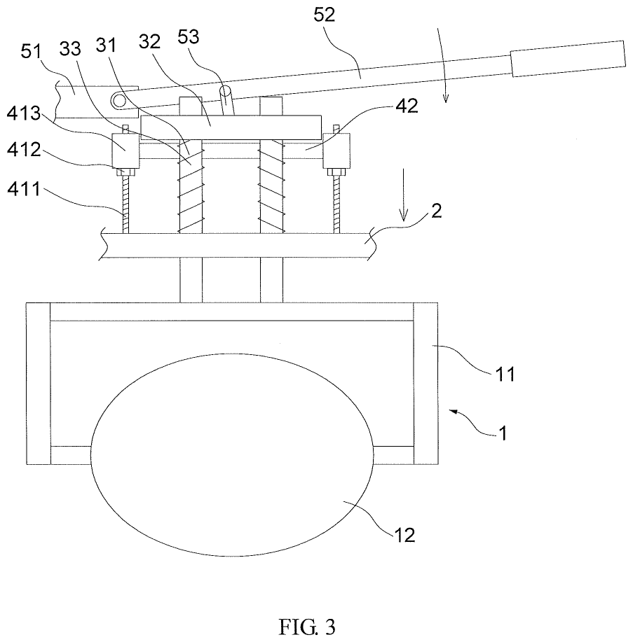

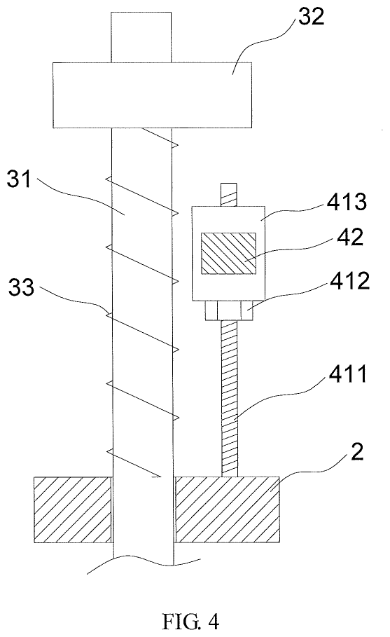

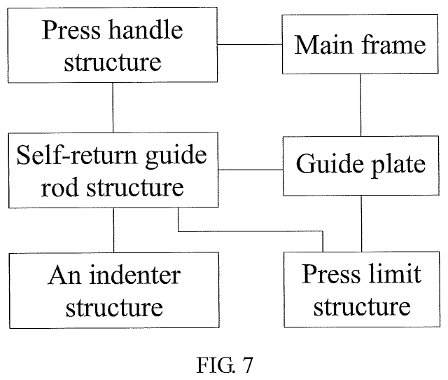

Referring to FIG. 1 to FIG. 7, the present invention discloses an inspection device. The inspection device comprises a main frame, an indenter structure 1, a guide plate 2, a self-return guide rod structure 3, a press limit structure 4, and a press handle structure 5. The guide plate 2 and the press handle structure 5 are connected to the main frame, respectively. The self-return guide rod structure 3 is slidably coupled to the guide plate 2 in an up-down direction. The press handle structure 5 is connected to an upper portion of the self-return guide rod structure 3. The indenter structure 1 is located under the guide plate 2. The indenter structure 1 is coupled to a lower end of the self-return guide rod structure 3. The press limit structure 4 is coupled to the guide plate 2. The press limit structure 4 is configured to limit the self-return guide rod structure 3 to slide in the up-down direction within a predetermined range. The highest operating position of the predetermined range can be limited by the guide plate 2. The lowest operating position can be limited by the press limit structure 4. After pressed to the lowest position, the indenter structure 1 cannot be further moved downward so as to limit the press force. The main frame is a peripheral support structure, not shown in the drawing, and is used for supporting the guide plate 2, the press handle structure 5 and the like. The shape and structure of the main frame is not limited.

The up-down direction is defined as: the direction that the self-return guide rod structure 3 is moved toward the indenter structure 1 is defined as the down direction, on the contrary, the up direction.

The inspection device of the present invention is used for pressing a display panel through the press handle structure 5 to drive the self-return guide rod structure 3 so as to move the indenter structure 1. The inspection device of the present invention also includes the press limit structure 4 to limit the self-return guide rod structure 3 to slide in the up-down direction within the predetermined range, so that the maximum displacement of each press is limited, that is, when pressed to the lowest, each press is able to reach the specific press force. The press force each time can be kept uniform to improve the accuracy of the inspection. Besides, the operator without special training can use the inspection device to perform inspection operations, thereby saving manpower and resources, reducing production costs and improving product quality.

In one embodiment, referring to FIG. 1 to FIG. 6 as a specific embodiment of the inspection device of the present invention, the self-return guide rod structure 3 includes at least one guide rod 31, a connecting block 32, and a return spring 33. The guide rod 31 has a longitudinal axis parallel to the slide direction of the guide plate 2. The guide plate 2 is provided with a guide hole for insertion of the guide rod 31. The indenter structure 1 is coupled to a lower end of the guide rod 31. The connecting block 32 is fixedly connected to an upper portion of the guide rod 31. The connecting block 32 is coupled to the press handle structure 5. The return spring 33 is fitted on the outer periphery of the guide rod 31. One end of the return spring 33 leans against the connecting block 32, and another end of the return spring 33 leans against the guide plate 2. When the press handle structure 5 is pressed downward, the connecting block 32 and the guide rod 31 are moved downward synchronously. Since the connecting block 32 is gradually driven to approach the guide plate 2, the return spring 33 is compressed to accumulate the return elastic force. When the connecting block 32 and the guide rod 31 are moved to the limit position restricted by the press limit structure 4, the connecting block 32 and the guide rod 31 cannot be further moved downward so that the lowest position of each press is uniformly restricted. This way is able to ensure that the press force to the lowest each time is uniform. When the press is not required, the press handle structure 5 is controlled and the connecting block 32 is lifted up by the return elastic force of the return spring 33, such that the connecting block 32 and the guide rod 31 are returned to the initial position without manual return, effectively improving the working efficiency of the device and simplifying the structure.

Selectively, referring to FIG. 1 to FIG. 6, this embodiment has two guide rods 31 which are parallel to each other to ensure that the guide rods 31 do not rotate along its radial direction during the press process to improve the smoothness of the use.

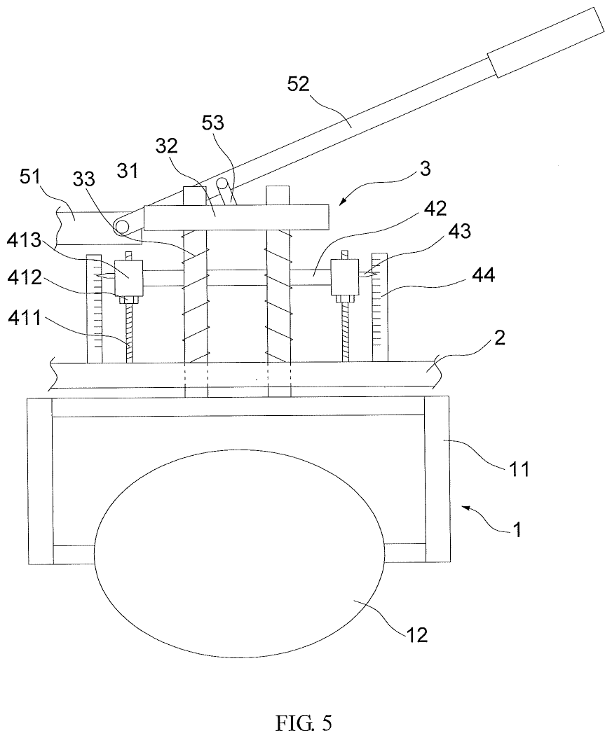

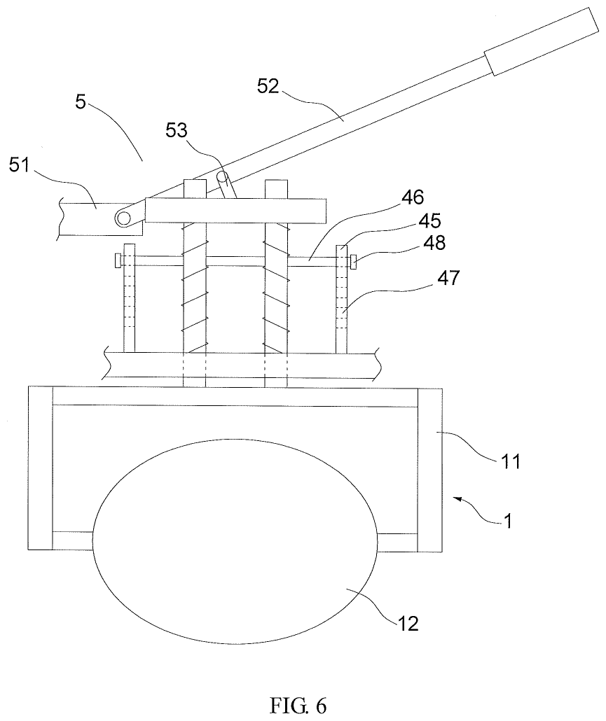

In one embodiment, referring to FIG. 1 to FIG. 3, FIG. 5 and FIG. 6 as a specific embodiment of the inspection device of the present invention, the press handle structure 5 includes a connecting seat 51, a press handle 52, and a connecting rod 53. The connecting seat 51 is connected to the main frame. One end of the press handle 52 is hinged to the connecting seat 51. One end of the connecting rod 53 is hinged to a middle portion of the press handle 52, and another end of the connecting rod 53 is hinged to the connecting block 32. One end of the press handle 52 is fixed relative to the main frame through the connecting seat 51. When the other end of the press handle 52 is pressed downward, the press handle 52 drives the connecting seat 51 to move downward through the connecting rod 53. The length of the press handle 52 may be set according to the actual demand, thereby achieving the best force transmission ratio, improving the efficiency of pressing, and simplifying the structure.

It is to be noted that, for ease of use, a hinge axle of the connecting seat 51 and the press handle 52 and a hinge axle of the press handle 52 and the connecting rod 53 are perpendicular to the up-down direction. The radial plane of the hinge rotation is parallel to the central axis of the at least two guide rods 31, which minimizes the space occupied by the structure and enhances the press efficiency.

In one embodiment, referring to FIG. 1 to FIG. 6 as a specific embodiment of the inspection device of the present invention, the press limit structure 4 includes a limit adjustment assembly 41 and a limit block 42. The limit block 42 is located under the connecting block 32. An upper end surface of the limit block 42 is configured to lean against a lower end surface of the connecting block 32. The limit block 42 is coupled to the guide plate 2 through the limit adjustment assembly 41. The limit adjustment assembly 41 is used to drive the limit block 42 to move in the up-down direction. The limit block 42 is a component that can be directly in contact with the connecting block 32. The limit adjustment assembly 41 is an assembly that adjusts the limit block 42 so that the lowest operating position of the connecting block 32 is limited. The lowest operating position is adjustable so that the press force can be adjusted. In general, the lower the lowest operating position is, the greater the press force would be.

In one embodiment, referring to FIG. 1 to FIG. 5 as a specific embodiment of the inspection device of the present invention, the limit adjustment assembly 41 includes at least two guide screw rods 411, guide nuts 412 corresponding to the guide screw rods 411 respectively, and guide seats 413 corresponding to the guide nuts 412 respectively. The guide screw rods 411 are disposed on the guide plate 2. The guide screw rods 411 each have a longitudinal axis parallel to the longitudinal axis of the guide rod 31. The guide nuts 412 are screwed to the guide screw rods 411, respectively. The guide seats 413 are fitted on the guide screw rods 411, respectively. The guide seats 413 are located on top of the guide nuts 412, respectively. The limit block 42 is coupled to the guide seats 413. The guide seats 413 are clearance fit with the guide screw rods 411 so as to slide along the guide screw rods 411, respectively. The guide seats 413 can be moved up and down by screwing the guide nuts 412, respectively. In order to ensure that the limit block 42 provides a stable support, this embodiment has at least two guide screw rods 411 to sustain the limit block 42 at different positions. Therefore, it is necessary to adjust each guide nut 412 at the same height when making an adjustment so as to ensure that the contact surface of the guide block 42 is fully in contact with the connecting block 32.

In one embodiment, referring to FIG. 5 as a specific embodiment of the inspection device of the present invention, the inspection device further includes at least one pointer 43 connected to a corresponding one of the guide seats 413 and at least one scale 44 disposed at an outer side of the corresponding guide seat 413 and corresponding to the pointer 43. The scale 44 is disposed on the guide plate 2. The graduations on the scale 44 indicate different press forces. The up and down movement of the guide seats 413 can directly indicate the press force of the position through the pointer 43, thereby providing the operator with an accurate adjustment basis and improving the working efficiency.

In one embodiment, as a specific embodiment of the inspection device of the present invention, the press limit structure 4 further includes a locking nut located at an upper portion of each guide seat 413. The locking nut is engaged with the upper portion of each guide seat 413. The locking nut is able to limit the top end of the guide seat 413 to prevent the guide seat 413 from disengaging from the guide screw rod 411.

In one embodiment, referring to FIG. 6 as a specific embodiment of the inspection device of the present invention, the press limit structure 4 includes a limit plate 45 and a limit rod 46. The limit plate 45 is disposed on the guide plate 2. The limit plate 45 is provided with perforations 47 arranged along the up-down direction. The limit rod 46 is insertedly connected to the limit plate 45 through the perforations 47. The limit rod 46 is located under the connecting block 32. An upper end surface of the limit rod 46 is configured to be in contact with the lower end surface of the connecting block 32. The side of each perforation 47 at a different height is marked with a corresponding graduation of the press force. When the limit rod 46 is inserted in the perforation 47 at a different height, a different limit effect can be obtained.

In one embodiment, referring to FIG. 6 as a specific embodiment of the inspection device of the present invention, in order to simplify the structure and enable the limit rod 46 to obtain a stable support, this embodiment has two limit plates 45 which are symmetrically arranged. The positions of the perforations 47 of the two limit plates 45 correspond to each other. Two ends of the limit rod 46 are inserted in the perforations 47 of the two limit plates 45, respectively. The two ends of the limit rod 46 are detachably coupled to fixing nuts 48, respectively. After the limit rod 46 is inserted, the displacement of the limit rod 46 in its own axial direction can be restricted by the fixing nuts 48 to prevent the limit rod 46 from disengaging from the limit plate 45.

Selectively, as a specific embodiment of the inspection device of the present application, in order to increase the efficiency of assembly and disassembly, the limit rod 46 is insertedly coupled to the fixing nuts 48.

In one embodiment, referring to FIG. 1 to FIG. 3, FIG. 5 and FIG. 6 as a specific embodiment of the inspection device of the present invention, the indenter structure 1 includes a support frame 11 and a contact block 12 disposed at a lower portion of the support frame 11. A lower end of the contact block 12 extends out of a lower end of the support frame 11. The support frame 11 is coupled to the lower end of the self-return guide rod structure 3. The support frame 11 provides a quick-release platform for the contact block 12. Two end faces of the contact block 12 are connected to mounting rods at two sides of the support frame 11 to complete the assembly, thereby improving the efficiency of assembly.

In one embodiment, referring to FIG. 1 to FIG. 3, FIG. 5 and FIG. 6 as a specific embodiment of the inspection device of the present invention, in order to optimize the accuracy of the press inspection, the contact block 12 has a curved contact surface.

In one embodiment, as a specific embodiment of the inspection device of the present invention, the contact block 12 is detachably connected to the support frame 11, for example, by means of an inserted connection or a snap-in connection, so that the contact block 12 can be replaced conveniently.

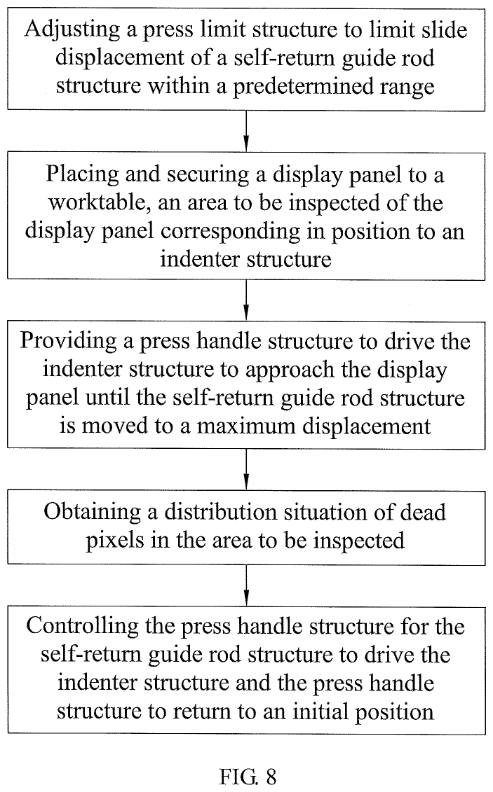

The present application also provides a display panel inspection method, referring to FIG. 8, comprising the steps of:

adjusting a press limit structure 4 to limit slide displacement of a self-return guide rod structure 3 within a predetermined range;

placing and securing a display panel to a worktable, an area to be inspected of the display panel corresponding in position to a indenter structure 1;

providing a press handle structure 1 to drive the indenter structure 1 to approach the display panel until the self-return guide rod structure 3 is moved to a maximum displacement;

obtaining a distribution situation of dead pixels in the area to be inspected; and controlling the press handle structure 5 for the self-return guide rod structure 3 to drive the indenter structure 1 and the press handle structure 5 to return to an initial position.

The dead pixels on the display panel show that the display panel does not meet the predetermined structural qualification conditions due to some flaws introduced during the production of the display panel. For example, the substrate is not clean, leaving particles on the substrate; during the process, the removing of photoresist is not performed completely, the photoresist residues remain on the display panel; during the process, abnormal image is introduced. In the process of inspection, due to the existence of the structural defects, the defect area will produce visible dead pixels when pressed. By inspecting dead pixels, the position and distribution of defects can be inspected. The press force will affect the accuracy of dead pixel inspection.

In some embodiments, the display panel may be, for example, an LCD display panel, an OLED display panel, a QLED display panel, a curved display panel, or other display panels. The display panel may also be a TN, OCB, VA type liquid crystal display panel when the display panel is an LCD display panel, but is not limited thereto.

The display panel inspection method of the present invention uses the aforesaid inspection device. When the display panel is pressed for inspection, the press force can be unified, that is, the press force corresponding to the maximum displacement position, so that the accuracy of the inspection is improved to save manpower and material resources, reduce production costs and improve product quality. In addition, after finishing the press, the press handle structure 5 and the indenter structure 1 are automatically returned to the initial position, and the operator does not need to return them manually, further improving the working efficiency.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An inspection device, comprising:
a main frame;
a guide plate, connected to the main frame;
a self-return guide rod structure, slidably coupled to the guide plate;
a press limit structure, coupled to the guide plate, the press limit structure being configured to limit the self-return guide rod structure to slide within a predetermined range;
a press handle structure, coupled to an upper portion of the self-return guide rod structure and the main frame respectively; and
an indenter structure, located under the guide plate and coupled to a lower end of the self-return guide rod structure.

2. The inspection device as claimed in claim 1, wherein the self-return guide rod structure includes:
at least one guide rod, the guide rod having a longitudinal axis parallel to a slide direction of the guide plate, the guide rod being inserted through a guide hole of the guide plate, a lower end of the guide rod being coupled to the indenter structure;
a connecting block, fixedly connected to an upper portion of the guide rod and coupled to the press handle structure; and
a return spring, fitted on an outer periphery of the guide rod, one end of the return spring leaning against the connecting block, another end of the return spring leaning against the guide plate.

3. The inspection device as claimed in claim 2, wherein the least one guide rod has two guide rods which are parallel to each other.

4. The inspection device as claimed in claim 2, wherein the press handle structure includes:
a connecting seat, connected to the main frame;
a press handle, one end of the press handle being hinged to the connecting seat; and
a connecting rod, one end of the connecting rod being hinged to a middle portion of the press handle, another end of the connecting rod being hinged to the connecting block.

5. The inspection device as claimed in claim 4, wherein a hinge axle of the connecting seat and the press handle and a hinge axle of the press handle and the connecting rod are perpendicular to the slide direction of the guide plate.

6. The inspection device as claimed in claim 2, wherein the press limit structure includes a limit adjustment assembly and a limit block, the limit adjustment assembly is configured to drive the limit block to move in a direction parallel to the slide direction of the guide plate, the limit block is located under the connecting block, an upper end surface of the limit block is configured to lean against a lower end surface of the connecting block, and the limit block is coupled to the guide plate through the limit adjustment assembly.

7. The inspection device as claimed in claim 6, wherein the limit adjustment assembly includes:
at least two guide screw rods, disposed on the guide plate, the guide screw rods each having a longitudinal axis parallel to the longitudinal axis of the guide rod;
guide nuts, corresponding to the guide screw rods respectively, the guide nuts being screwed to the guide screw rods respectively;
guide seats, corresponding to the guide nuts respectively, the guide seats being fitted on the guide screw rods respectively, the guide seats being located on top of the guide nuts respectively and coupled to the limit block.

8. The inspection device as claimed in claim 7, further comprising:
at least one pointer, connected to a corresponding one of the guide seats;
at least one scale, corresponding to the pointer, the scale being disposed at an outer side of the corresponding guide seat and located on the guide plate.

9. The inspection device as claimed in claim 7, wherein the press limit structure further includes a locking nut located at an upper portion of each guide seat, and the locking nut is engaged with the upper portion of each guide seat.

10. The inspection device as claimed in claim 2, wherein the press limit structure includes:
a limit plate, disposed on the guide plate, the limit plate being provided with perforations; and
a limit rod, coupled to the limit plate through the perforations, the limit rod being located under the connecting block, an upper end surface of the limit rod being configured to be in contact with a lower end surface of the connecting block.

11. The inspection device as claimed in claim 10, wherein the press limit structure further includes fixing nuts, and the fixing nuts are detachably connected to two end of the limit rod.

12. The inspection device as claimed in claim 11, wherein the limit rod is insertedly connected to the fixing nuts.

13. The inspection device as claimed in claim 1, wherein the indenter structure includes:
a support frame, connected to the lower end of the self-return guide rod structure; and
a contact block, disposed at a lower portion of the support frame, a lower end of the contact block extending out of a lower end of the support frame.

14. The inspection device as claimed in claim 13, wherein the contact block has a curved contact surface.

15. An inspection device, comprising:
a main frame;
a guide plate, connected to the main frame;
a self-return guide rod structure, slidably coupled to the guide plate;
a press limit structure, coupled to the guide plate, the press limit structure being configured to limit the self-return guide rod structure to slide within a predetermined range;
a press handle structure, coupled to an upper portion of the self-return guide rod structure and the main frame respectively; and
an indenter structure, located under the guide plate and coupled to a lower end of the self-return guide rod structure;
wherein the self-return guide rod structure includes:
at least one guide rod, the guide rod having a longitudinal axis parallel to a slide direction of the guide plate, the guide rod being inserted through a guide hole of the guide plate, a lower end of the guide rod being connected to the indenter structure;
a connecting block, fixedly connected to an upper portion of the guide rod and coupled to the press handle structure; and
a return spring, fitted on an outer periphery of the guide rod, one end of the return spring leaning against the connecting block, another end of the return spring leaning against the guide plate;
wherein the press handle structure includes:
a connecting seat, connected to the main frame;
a press handle, one end of the press handle being hinged to the connecting seat; and
a connecting rod, one end of the connecting rod being hinged to a middle portion of the press handle, another end of the connecting rod being hinged to the connecting block;
wherein the press limit structure includes a limit adjustment assembly and a limit block, the limit adjustment assembly is configured to drive the limit block to move in a direction parallel to the slide direction of the guide plate, the limit block is located under the connecting block, an upper end surface of the limit block is configured to lean against a lower end surface of the connecting block, and the limit block is coupled to the guide plate through the limit adjustment assembly;
wherein the limit adjustment assembly includes:
at least two guide screw rods, disposed on the guide plate, the guide screw rods each having a longitudinal axis parallel to the longitudinal axis of the guide rod;
guide nuts, corresponding to the guide screw rods respectively, the guide nuts being screwed to the guide screw rods respectively;
guide seats, corresponding to the guide nuts respectively, the guide seats being fitted on the guide screw rods respectively, the guide seats being located on top of the guide nuts respectively and coupled to the limit block;
wherein the indenter structure includes:
a support frame, coupled to the lower end of the self-return guide rod structure; and
a contact block, disposed at a lower portion of the support frame, a lower end of the contact block extending out of a lower end of the support frame.

16. The inspection device as claimed in claim 15, wherein the least one guide rod has two guide rods which are parallel to each other.

17. The inspection device as claimed in claim 15, wherein a hinge axle of the connecting seat and the press handle and a hinge axle of the press handle and the connecting rod are perpendicular to the slide direction of the guide plate.

18. The inspection device as claimed in claim 15, further comprising:
at least one pointer, connected to a corresponding one of the guide seats;
at least one scale, corresponding to the pointer, the scale being disposed at an outer side of the corresponding guide seat and located on the guide plate.

19. The inspection device as claimed in claim 15, wherein the press limit structure further includes a locking nut located at an upper portion of each guide seat, and the locking nut is engaged with the upper portion of each guide seat.

20. A display panel inspection method, comprising the steps of:
adjusting a press limit structure to limit slide displacement of a self-return guide rod structure within a predetermined range;
placing and securing a display panel to a worktable, an area to be inspected of the display panel corresponding in position to an indenter structure;
providing a press handle structure to drive the indenter structure to approach the display panel until the self-return guide rod structure is moved to a maximum displacement;
obtaining a distribution situation of dead pixels in the area to be inspected; and
controlling the press handle structure for the self-return guide rod structure to drive the indenter structure and the press handle structure to return to an initial position.
